(19) United States
(12) Patent Application Publication
(10) Pub. No.: US 2005/0036938 A1
(43) Pub. Date: Feb. 17, 2005

(54) Method for synthesizing nanoparticles of metal sulfides

(76) Inventor: Taegwhan Hyeon, Seoul (KR)

Correspondence Address: MARGER JOHNSON & McCOLLOM, P.C., 1030 S.W. Morrison Street, Portland, OR, 97205, US

(21) Appl. No.: 10/641,394

(22) Filed: Aug. 13, 2003

(51) Int. Cl. C01B 17/20

(52) U.S. Cl. 423/561.1

(57) ABSTRACT

A synthetic method of fabricating highly crystalline and uniform nanoparticles of metal sulfides, doped metal sulfides, and multi-metallic sulfides disclosed, using no-toxic and inexpensive reagents. A typical synthetic method comprises the steps of, synthesis of metal-surfactant complexes from the reaction of metal precursors and surfactant, addition of sulfur reagent to the solution containing said metal-surfactant complexes followed by heating to high temperature, aging at that temperature to produce metal sulfide nanoparticles and completing the formation of synthesis of nanoparticles metal sulfides and multi-metallic sulfides by adding a poor solvent followed by centrifuging.

### TECHNICAL FIELD

The present invention relates to a method for synthesizing highly crystalline nanoparticles of metal sulfides and multi-metallic sulfides through the reaction of metal salts and sulfur.

### BACKGROUND ART

The advent of semiconductor nanoparticles has made a significant impact on many technological areas including biological labeling and diagnostics, light emitting diodes, electroluminescent devices, photovoltaic devices, lasers, high density single-electron transistor devices, highly efficient laser beam sources, and high density magnetic data storage. [Shouheng Sun, et al., “Spin-dependent tunneling in self-assembled cobalt-nanocrystal superlattices”, Science, 290 (2000) 1131] These nanometer-sized particles possess new and interesting electrical, magnetic and optical properties compared to the existing and widely known particles larger than micrometer range. [Bawendi, M. G., et al., “Self-organization of CdSe Nanocrystallites into Three-dimensional Quantum Dot Superlattices”, Science, 270 (1995) 1335] The surface property of the nanoparticle-sized materials is very critical in determining their characteristics, because the nanoparticles have a surface to volume ratio as well as a high surface to defect ratio in comparison with ordinary bulk materials. In addition, quantum confinement effect of the nanoparticles having intermediate sizes between molecules and macroscopic bulk materials, has an increased interest technologically. Such nanoparticles have been attracting diversified applications in nanodevices, nonlinear optical materials, catalysts, and data storage devices. In particular, there have been an increasing interest in developing methods of synthesizing the group II-VI semiconductor nanoparticles which have well defined shapes, sizes and high crystallinity. Monodisperse(or uniform-sized) nanoparticles with a narrow particle size distribution is an important property in various applications because quantum effect is dependent upon their size.

Recently, intensive researches have been conducted for developing electronic and optical devices using semiconductor nanoparticles. These devices can be realized by virtue of the advances in the synthetic methods of semiconductor nanoparticles. However, such methods for synthesizing sufide nanoparticlesare highly toxic and also often use very expensive precursors, including dimethyl cadmium, diethyl zinc, bis(trimethylsilyl) sulfide, sodium sulfide, and hydrogen sulfide, and as a result such costly synthesis methods have hampered large-scale and economical synthesis, and subsequently resulted in expensive applications of such semiconductor nanoparticles. In particular, it is very difficult to synthesize semiconductor sulfide nanoparticles with a narrow particle size distribution and well-defined shapes by using the synthetic methods that have been developed so far. In addition to the afro-mentioned problems, most synthetic methods rely on the method of short-burst of nucleation induced by the rapid injection of precursors into hot surfactant solutions followed by aging [Bawndi, M., G., et al. “Synthesis and Characterization of Nearly Monodisperse CdE(E=sulfur, selenium or tellurium) semiconductor nanocrystallites”, Journal of The American Chemical Society, 115 (1993) 8706], which method has been most widely used for synthesizing various kinds of nanoparticles. Using this method of short-burst of nucleation, very small quantity, typically less than 100 milligram, of nanoparticles is produced, thereby such method is not suitable for large-scale synthesis of sulfide nanoparticles. Cheon, et al. reported a synthesis method of sulfide nanoparticles by using thermal decomposition of single-source precursors having thiocarbamate ligand including Cd(S₂CNEt₂)₂. [Cheon, J.,et al., “Controlled Synthesis of Multi-armed CdS Nanorod Architectures using Monosurfactant Sstem”, Journal of The American Chemical Society, 123 (2001) 5151] However, the milligram-scale nanoparticles obtained using this synthetic method exhibited a broad particle size distribution.

It is desirable to synthesize multi-component metal sulfide nanoparticles with different elements such as ZnS/Ag⁺, Cl⁻ or MnₓCd₁₋ₓS for industrial applications. Different reactivity of metal precursors makes it difficult to synthesize homogeneous crystalline multi-metallic sulfides. Murase, N., et al. prepared Mn²⁺ doped ZnS nanoparticles using conventional sol-gel process [Cheon, J., “Architectural Control of Magnetic Semiconductor Nanocrystals”, Journal of The American Chemical Society, 124 (2002) 615; Murase, N., “Fluorescence and EPR Characteristics of Mn²⁺-doped ZnS Nanocrystals Prepared by Aqueous Colloidal Method”, Journal of Physical Chemistry B, 103 (1999) 754], whereby doped ZnS nanoparticles with a broad particle size distribution were synthesized.

The shape of the nanoparticles is an important factor influencing the property of the nanoparticles. Alivisatos, et al. reported that CdSe rod-shaped nanoparticles (nanorods), with high aspect ratio exhibit high quantum efficiency for the solar cell applications. [Alivisatos, A. P., “Hybrid Nanorod-polymer Solar Cells”, Science, 295 (2002) 2425] It demonstrates that the optoelectronic properties of anisotropic rod-shaped nanoparticles are superior to those of spherically-shaped nanoparticles. However, in case of II-VI metal sulfide nanocrystals such as CdS and ZnS, the synthesis method for monodisperse nanoparticles with a narrow particle size distribution and well-defined shapes has not been reported yet.

Therefore, the main objective of the present invention is to disclose a method forsynthesizing semiconductor nanoparticles having a narrow particle size distribution and well-defined shapes using inexpensive and non-toxic reagents in order to overcome the afore-mentioned deficiencies.

### BRIEF DESCRIPTION OF THE DRAWINGS

FIG. 1 is a schematic flow chart showing a synthetic procedure of nanoparticles of metal sulfides and multi-metallic sulfides according to the present invention.

FIG. 2 is an exemplary transmission electron microscopic (TEM) image of the spherical zinc sulfide nanoparticles with the size distribution ranging from 7 nm to 11 nm in diameter synthesized in Embodiment 1.

FIG. 3 is an exemplary TEM image of monodisperse 11 nm of zinc sulfide nanoparticles synthesized in Embodiment 1.

FIG. 4 is an exemplary HRTEM (high resolution transmission electron microscopic) image of 11 nm of zinc sulfide nanoparticles synthesized in Embodiment 1.

FIG. 5 is an exemplary high resolution TEM (HRTEM) image of monodisperse cube-shaped lead sulfide nanoparticles of 13 nm in diameter synthesized in Embodiment 2.

FIG. 6 is an exemplary HRTEM image of monodisperse cube-shaped lead sulfide nanoparticles of 13 nm in diameter synthesized in Embodiment 2.

FIG. 7 is an exemplary high resolution TEM image of monodisperse lead sulfide nanoparticles of 9 nm in diameter synthesized according to Embodiment 3.

FIG. 8 is an exemplary high resolution TEM image of monodisperse lead sulfide nanoparticles of 8 nm in diameter synthesized in Embodiment 4.

FIG. 9 is an exemplary high resolution TEM image of monodisperse lead sulfide nanoparticles of 6 nm in diameter synthesized in Embodiment 5.

FIG. 10 is an exemplary TEM image of cadmium sulfide nanoparticles having shapes of rods, bipods, and tripods synthesized in Embodiment 6.

FIG. 11 is an exemplary HRTEM image of the bipod cadmium sulfide nanoparticles synthesized in Embodiment 6.

FIG. 12 is an exemplary TEM image of spherical cadmium sulfide nanoparticles of 5.1 nm in diameter synthesized in Embodiment 7.

FIG. 13 is an exemplary TEM image of rod-shaped manganese sulfide nanoparticles with average size of 20 nm (thickness)×37 nm (length) synthesized in Embodiment 8.

FIG. 14 is an exemplary HRTEM image of rod-shaped manganese sulfide nanoparticles synthesized in Embodiment 8.

FIG. 15 is an exemplary TEM image of a bullet-shaped manganese sulfide nanoparticles with average size of 17 nm (thickness)×44 nm (length) synthesized in to Embodiment 9.

FIG. 16 is an exemplary TEM image of a 2-dimensional array of hexagon-shaped manganese sulfide nanoparticles synthesized in Embodiment 10.

FIG. 17 is an exemplary transmission electron microscope (TEM) image of the Mn²⁺ doped zinc sulfide nanoparticles synthesized according to Embodiment 11.

### DETAILED DESCRIPTION OF THE INVENTION

The present invention is to disclose synthetic methods of synthesizing uniform nanoparticles of metal sulfides and multi-metallic sulfides using non-toxic and inexpensive reagents including metal salts and sulfur. Using said synthetic methods and by varying the synthetic conditions, the particle sizes and shapes are controlled in reproducible manners.

Another object of the present invention is to disclose a synthetic method of synthesizing nanoparticles of metal sulfides and multi-metallic sulfides with the characteristics, where the nanoparticles can be dispersed many times in various solvents without being aggregated, and the nanoparticles maintain the same particle size and also they do not aggregate even when said nanoparticles are recovered in a powder form. Such physical properties of non-aggregation and maintaining the same particle size when said nanoparticles are recovered according to the present invention expand the possibility of applications area and the usability of said nanoparticles and also suggest an improved possibility of recycling and reusing.

Another object of the present invention is to disclose a synthetic method of synthesizing multi-metallic sulfide nanoparticles, by which the composition of multi-metallic sulfide nanoparticles is easily controlled.

Another object of the present invention is to disclose methods of synthesizing highly crystalline and uniform metal sulfides and multi-metallic sulfides using inexpensive and non-toxic reagents.

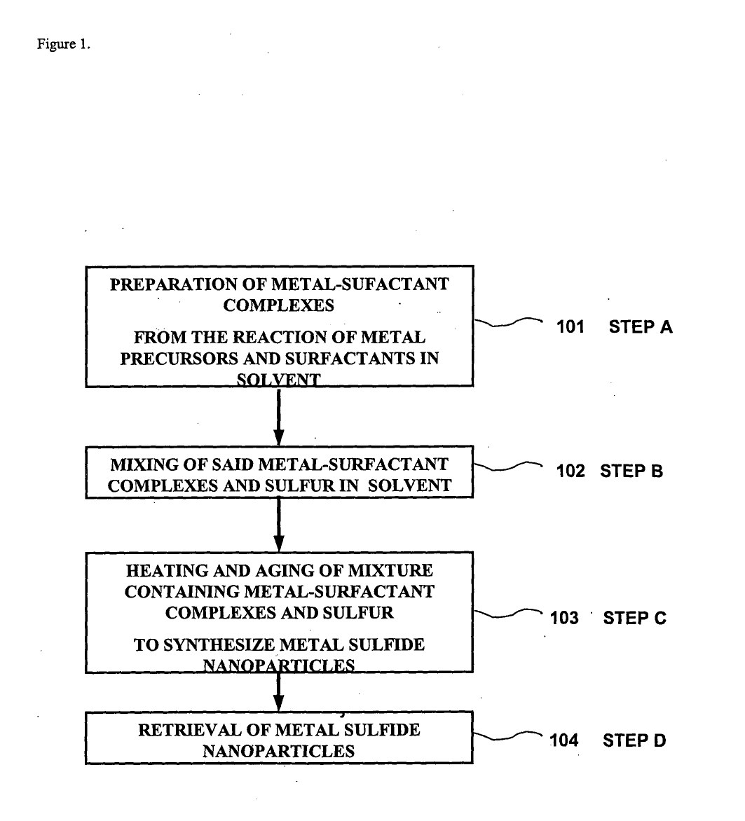

The synthetic method of synthesizing nanoparticles of metal sulfides and multi-metallic sulfides is described in reference to FIG. 1 in the following. FIG. 1 is a flowchart showing the process of synthesizing nanoparticles of metal sulfides and multi-metallic sulfides according to the present invention.

Specifically, according to the present invention and in reference to FIG. 1, nanoparticles of metal sulfide is synthesized by the following four steps described below; Step A 101: metal-surfactant complexes are synthesized by a process of reaction of metal precursors and surfactants in a solvent. Step B 102: Sulfur precursor was dissolved in a solvent containing suitable surfactant and this solution is added to the solution containing said metal-surfactant complexes. Step C 103: Resulting mixture solution containing said metal-surfactant complexes and sulfur was heated to high temperature and aged at that temperature to synthesize metal sulfide nanoparticles. Step D 105: Completion of the formation of said synthesized metal sulfide nanoparticles by adding a poor solvent followed by centrifuging, retrieving said metal sulfide nanoparticles.

More specifically, according to the present invention in reference to FIG. 1, in Step A 101 in synthesizing metal sulfide and multi-metallic sulfide nanoparticles, metal ion-surfactant complex is formed at a temperature ranging from 20° C. to 400° C.

According to the present invention, in reference to FIG. 1, in Step A 101, for synthesizing nanoparticles of metal sulfides and multi-metallic sulfides, the following metal salts composed of metal cations including typically cadmium[Cd], zinc[Zn], mercury[Hg], lead[Pb], manganese[Mn], iron[Fe], cobalt[Co], nickel[Ni], molybdenum[Mo], vanadiumm, niobium[Nb], aluminum[Al], titanium[Ti], copper[Cu], gallium[Ga], germanium[Ge], indium[In], tin[Sn], antimony[Sb], tantalum[Ta], tungsten[W], and anions including typically chloride[Cl⁻], bromide[Br⁻], nitrate[NO₃], sulfate[SO₄²], acetate[CH₃COO⁻], acetylacetonate[CH₃COCH═C(O⁻)CH₃], fluoride[F⁻], phosphate [PO₄³], oxalate[COO⁻], perchlorate[ClO₄⁻]and alkoxides[RO⁻] can be used as metal precursors. Furthermore, mixtures of any combinations of two or more metal salts listed above can also be used as catalyst precursors according to the present invention. Typical precursors are metal chlorides including typically lead chloride [PbCl₂], zinc chloride [ZnCl₂], cadmium chloride [CdCl₂], manganese chloride [MnCl₂], silver chloride [AgCl], copper chloride [CuCl₂], and metal acetates including typically lead acetate [Pb(OAc)₂], zinc acetate [Zn(OAc)₂], cadmium acetate [Cd(OAc)₂], manganese actate [Mn(OAc)₂], and metal nitrates including typically lead nitrate [Pb(NO₃)₂], zinc nitrate [Zn(NO₃)₂], cadmium nitrate [Cd(NO₃)₂], manganese nitrate [Mn(NO₃)₂], silver nitrate [AgNO₃], copper nitrate [Cu(NO₃)₂], and metal sulfates including typically lead sulfate [PbSO₄], zinc sulfate [ZnSO₄], cadmium sulfate [CdSO₄], manganese sulfate [MnSO₄], silver sulfate [Ag₂SO₄], and copper sulfate [CuSO₄].

According to the present invention, referring to FIG. 1, in Step A 101, following surfactants can be used for stabilizing the nanoparticles including cationic surfactants including typically alkyltrimethylammonium halides such as cetyltrimethylammonium bromide, neutral surfactants including typically oleic acid, trioctylphosphine oxide(TOPO), triphenylphosphine(TPP), and trioctylphosphine(TOP), alkyl amines, RNH₂, where R is alkyl groups with 3-18 carbons, such as oleylamine, octylamine, and hexadecylamine, and trialkylamine and alkyl thiols, and anionic surfactants including typically sodium alkyl sulfates and sodium alkyl phosphates. Mixtures of two or more surfactants can be used as described in some cases.

According to the present invention, referring to FIG. 1, in Step B 102, elemental sulfur is used as sulfur source (sulfiding reagent).

According to the present invention, referring to FIG. 1, in Step A 101, and in Step B 102, the following solvents are used including typically ethers such as octyl ether, butyl ether, hexyl ether and decyl ether, heterocyclic compounds such as pyridine and tetrahydrofurane(THF), and also aromatic compounds such as toluene, xylene, mesitylene, benzene, and dimethyl sulfoxide(DMSO), and dimethylformamide(DMF), and alcohols such as octyl alcohol, and decanol, and hydrocarbons such as heptane, octane, decane, dodecane, tetradecane, hexadecane, and also water. The solvents used in the present invention should have high enough boiling temperature because the metal-surfactant precursors must be decomposed and be reacted with sulfur to produce nanoparticles of metal sulfides and multi-metallic sulfides.

According to the present invention, in reference to FIG. 1, in Step A 101, in synthesizing metal-surfactant complexes, the reaction temperature ranges from 0° C. to 350° C.

According to the present invention and in reference to FIG. 1, in Step B 102, sulfur is dissolved in a solution containing surfactant and solvent at a temperature ranging from 20° C. to 100° C., and said sulfur solution was added to the solution containing said metal-surfactant complexes.

According to the present invention, in reference to FIG. 1, in Step B 102, the molar ratios of metal precursor to sulfur range in general, from 1: 0.1 to 1: 100, and preferably in the range from 1: 0.1 to 1: 20.

According to the present invention and in reference to FIG. 1, in step C 103, the aging temperature is varied from 60° C. to 400° C. depending on the desired sizes and shapes of the nanoparticles.

According to the present invention and in reference to FIG. 1, in step C 103, the aging time is varied 10 seconds to 48 hours.

According to the present invention and in reference to FIG. 1, in step D 104, nanoparticles of metal sulfides and multi-metallic sulfides are separated and retrieved by adding a poor solvent, followed by centrifugation, where said poor solvent is a solvent that can not disperse nanoparticles effectively and induce the precipitation of the nanoparticles.

### BEST MODES FOR CARRYING OUT THE INVENTION

As aforementioned, nanoparticles of metal sulfides and multi-metallic sulfides are synthesized according to the present invention, where such nanoparticles exhibit narrow particle size distributions, various shapes, and highly crystalline nature.

The procedures and results of the best modes of carrying out the present invention are described in the following. However, the procedures and results presented here are merely illustrative examples of carrying out the implementation of the underlying ideas and procedures of the present invention, and the presentation of the exemplary embodiments given in the following is neither intended for exhaustively illustrating the basic ideas and procedures nor limiting the scope of the present invention. Furthermore, those who are familiar with the art should be able to easily derive variations and modifications of the underlying ideas and procedures of the present invention.

Embodiment 1: Synthesis of Monodisperse and Spherically Shaped Zinc Sulfide Nanoparticles

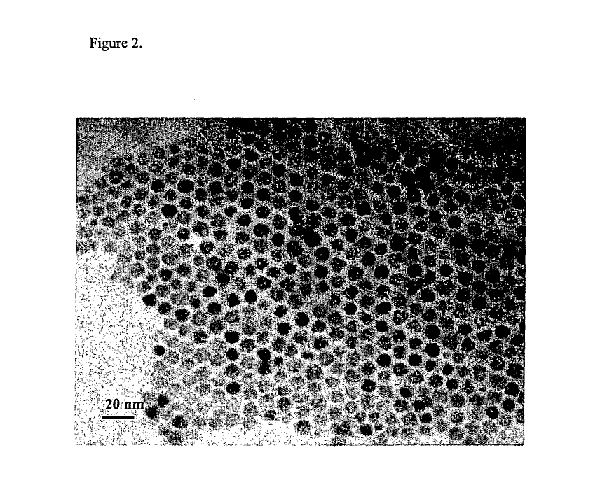

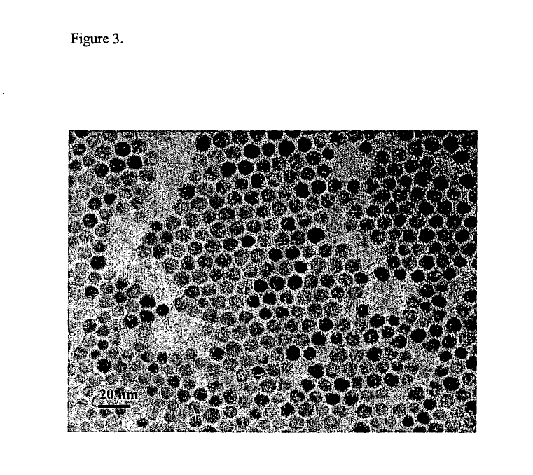

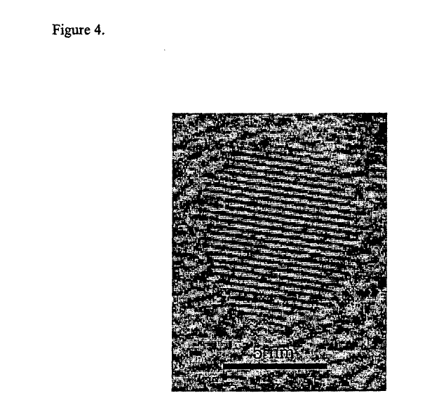

As a first exemplary embodiment of synthesizing monodisperse and spherically shaped zinc sulfide nanoparticles according to the present invention disclosed here, zinc-oleylamine solution was prepared by heating 10 ml of oleylamine and 2.3 g of TOPO containing 2 mmol of ZnCl₂ at 170° C. for 1 hour. 6 mmol of sulfur dissolved in 2.5 ml oleylamine was injected to zinc-oleylamine solution at room temperature. This mixture was heated to 320° C. and aged for 1 hour at the same temperature. The resulting solution was cooled to room temperature, and ethanol was added to yield a white precipitate, which was then separated by centrifuging. The resulting supernatant was discarded. After repeating this washing process at least three times, remaining ethanol was removed by vacuum drying. The resulting product was re-dispersed easily in hexane. The TEM(Transmission Electron Microscope) image of the resulting product, zinc sulfide nanoparticles, synthesized by the methods presented here according to the present invention is shown in FIG. 2. TEM image of zinc sulfide nanoparticles shows that nanoparticles have the size distribution ranging from 7 nm to 11 nm. 11 nm zinc sulfide nanoparticles were separate by adding small portion of ethanol to hexane solution containing said zinc sulfide nanoparticles. FIG. 3 shows an exemplary TEM image of the 11 nm sized zinc sulfide nanoparticles. The HRTEM(High Resolution Transmission Electron Microscope) image of 11 nm sized ZnS nanoparticle is shown in FIG. 4.

Embodiment 2: Synthesis of Monodisperse 13 nm Sized Lead Sulfide Nanoparticles

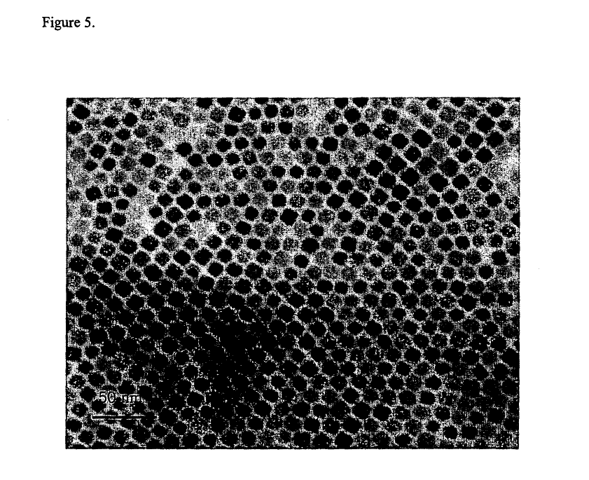

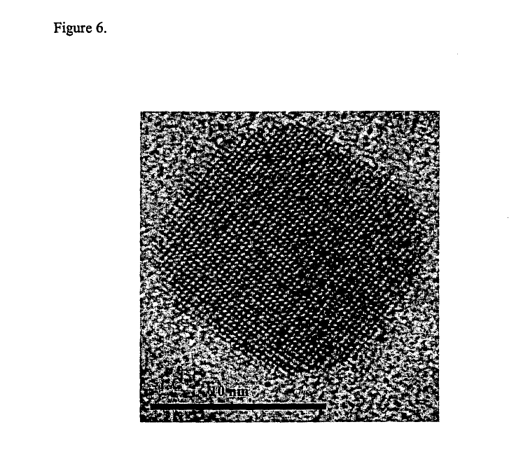

One (1) mmol of PbCl₂ (0.28 g) was added to 5 mL of oleylamine at room temperature and the resulting solution was heated to 90° C. under vacuum, forming a homogeneous and clear solution. 0.83 mmol of elemental sulfur (27 mg) was dissolved in 2.5 mL of oleylamine, and the resulting sulfur solution was injected into the Pb-oleylamine complex solution at 90° C. The resulting mixture was heated to 220° C. and aged at that temperature for 1 hour, resulting in a black colloidal solution. The resulting solution was cooled to room temperature, and ethanol was added to yield a deep blue colored precipitate, which was then separated by centrifuging. The resulting supernatant was discarded. After repeating this washing process at least three times, remaining ethanol was removed by vacuum drying. The resulting product was re-dispersed easily in hexane to form desired PbS nanoparticles. The transmission electron microscopic (TEM) image of the PbS nanocrystals, shown in FIG. 5, revealed uniform 13 nm sized nanocrystals. The particle shape is nearly cubic and the high resolution transmission electron microscopic (HRTEM) image of a single nanoparticle, shown in FIG. 6, demonstrated a cross lattice pattern, demonstrating the highly crystalline nature of the nanoparticles.

Embodiment 3: Synthesis of Monodisperse 9 nm Sized Lead Sulfide Nanoparticles

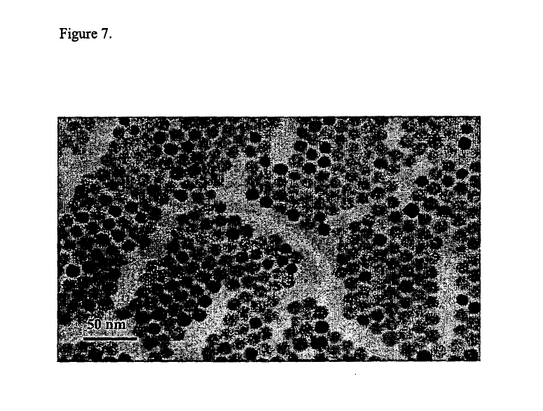

Monodisperse lead sulfide nanoparticles of 9 nm in diameter were synthesized using the same reaction conditions described in Embodiment 3, except that the amount of the sulfur used is reduced to 0.67 mmol (21 mg). An exemplary TEM image of the 9 nm sized lead sulfide nanoparticles synthesized according to the present invention is as shown in FIG. 7, indicating that monodisperse 9 nm sized lead sulfide nanoparticles are produced.

Embodiment 4: Synthesis of Monodisperse 8 nm Sized Lead Sulfide Nanoparticles

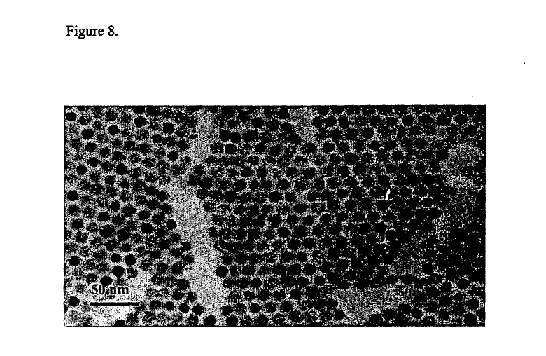

Monodisperse lead sulfide nanoparticles of 8 nm in diameter were synthesized using the same reaction conditions described in Embodiment 3, except that the amount of the sulfur used is reduced to 0.5 mmol (16 mg). An exemplary TEM image of the 8 nm lead sulfide nanoparticles synthesized according to the present invention is as shown in FIG. 8, indicating that monodisperse 8 nm sized lead sulfide nanoparticles are produced.

Embodiment 5: Synthesis of Monodisperse 6 nm Sized Lead Sulfide Nanoparticles

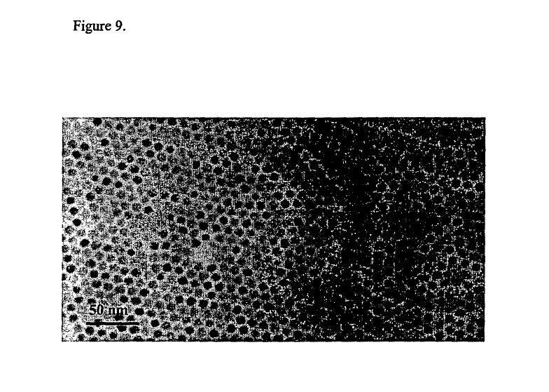

Monodisperse lead sulfide nanoparticles of 6 nm in diameter were synthesized using the same reaction conditions described in Embodiment 3, except that the amount of the sulfur used is reduced to 0.33 mmol (10.5 mg). An exemplary TEM image of the 6 nm lead sulfide nanoparticles synthesized according to the present invention is as shown in FIG. 9, indicating that monodisperse 6 nm sized lead sulfide nanoparticles are produced.

Embodiment 6: Synthesis of Rod, Bipod, Tripod Shaped CdS Nanoparticles

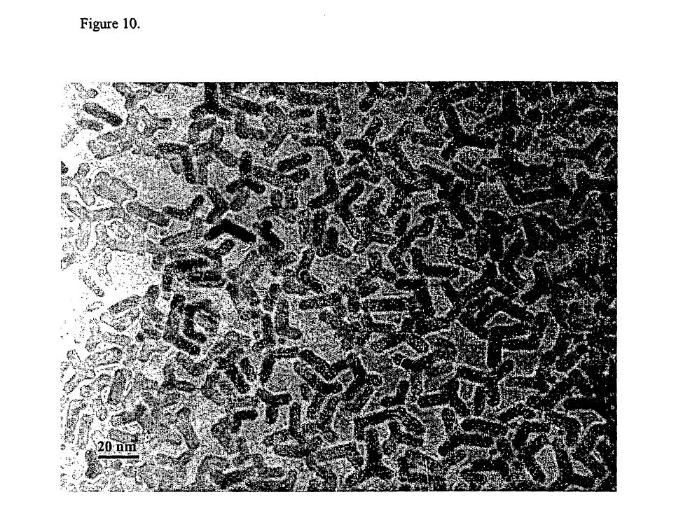

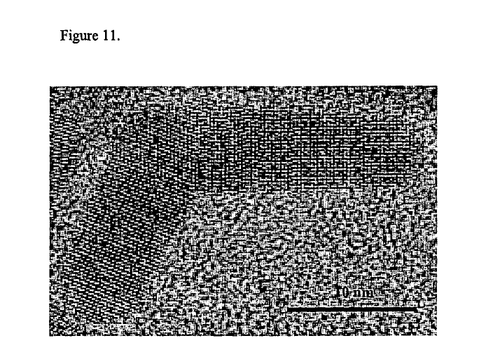

Rod-shaped CdS nanocrystals were synthesized using a reaction mixture with a cadmium to sulfur molar ratio of 1:6. More specifically, 1 mmol of CdCl₂ in 10 ml of oleylamine was heated at 90° C. to generate Cd-oleylamine complexes. 6 mmol of sulfur in 5 ml of oleylamine was injected into the Cd-oleylamine complexes at 90° C. The resulting mixture was heated to 140° C. and aged at that temperature for 20 hours. The resulting solution was cooled to room temperature, and ethanol was added to yield an orange colored precipitate, which was then separated by centrifuging. The resulting supernatant was discarded. After repeating this washing process at least three times, remaining ethanol was removed by vacuum drying. The resulting product was redispersed easily in hexane to form desired CdS nanoparticles. TEM image of the CdS nanocrystals, shown in FIG. 10, revealed that these rod-shaped nanocrystals have an average thickness of 5.4 nm and an average length of 20 nm. The HRTEM image of CdS bipod nanoparticles in FIG. 11 illustrates a lattice fringe pattern indicating highly crystalline nature of the nanoparticles.

Embodiment 7: Synthesis of Spherical-Shaped CdS Nanoparticles

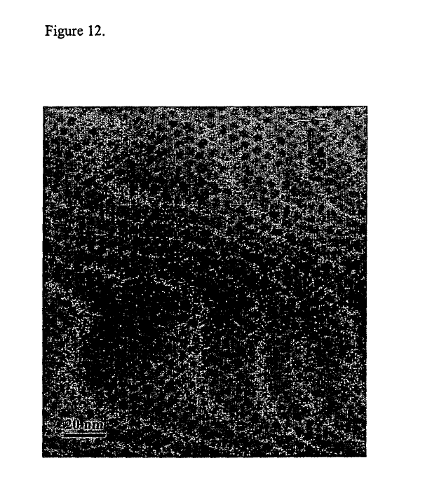

Spherical-shaped CdS nanocrystals were synthesized using a reaction mixture with a cadmium to sulfur molar ratio of 2:1. More specifically, 1.5 mmol of CdCl₂ in 10 ml of oleylamine was heated at 160° C. to generate Cd-oleylamine complexes. 0.75 mmol of sulfur in 5 ml of oleylamine was injected into the Cd-oleylamine complexes at 160° C. The resulting mixture was aged at that temperature for 6 hours. The resulting solution was cooled to room temperature, and ethanol was added to yield a orange colored precipitate, which was then separated by centrifuging. The resulting supernatant was discarded. After repeating this washing process at least three times, remaining ethanol was removed by vacuum drying. The resulting product was re-dispersed easily in hexane to form desired spherical CdS nanoparticles. FIG. 12 shows the TEM image of 5.1 nm sized spherical CdS nanocrystals synthesized using a reaction mixture with a cadmium to sulfur molar ratio of 2:1.

Embodiment 8: Synthesis of Rod-Shaped MnS Nanoparticles

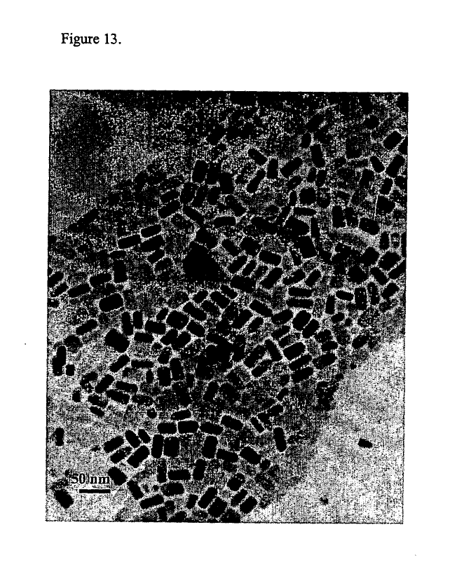

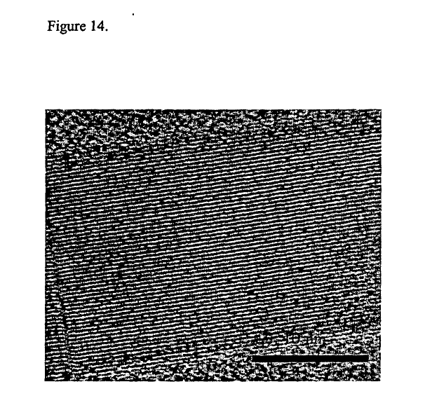

Homogeneous Mn-oleylamine complexes were prepared by reacting 2 mmol of MnCl₂ and 10 ml of oleylamine at 120° C. 2 mmol of elemental sulfur was dissolved in 5 ml of oleylamine at room temperature. The sulfur dissolved in oleylamine was injected into the Mn-oleylamine complex and was heated to 240° C. The resulting solution was aged at that temperature for 2 hours. The resulting solution was cooled to room temperature, and ethanol was added to yield precipitate, which was then separated by centrifuging. The resulting supernatant was discarded. After repeating this washing process at least three times, remaining ethanol was removed by vacuum drying. The resulting product was re-dispersed easily in hexane to form desired MnS nanoparticles. FIG. 13 shows the TEM image of rod-shaped manganese sulfide nanoparticles with average size of 20 nm (thickness)×37 nm (length). The HRTEM image is shown in FIG. 14.

Embodiment 9: Synthesis of Bullet-Shaped MnS Nanoparticles

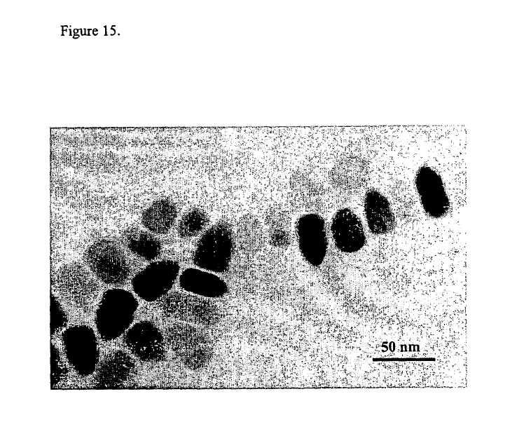

Manganese-oleylamine complex was prepared by reacting 4 mmol of MnCl₂ and 10 ml of oleylamine at 120° C. 2 mmol of sulfur dissolved in 5 ml of oleylamine was added into the manganese-oleylamine complex at 60° C. and the resulting mixture was aged for 2 hours at 280° C. During heating process, the color of reacting mixture changed from red to orange, indicating visually MnS nanoparticles were formed. The resulting solution was cooled to room temperature, and ethanol was added to yield precipitate, which was then separated by centrifuging. The resulting supernatant was discarded. After repeating this washing process at least three times, remaining ethanol was removed by vacuum drying. The resulting product was re-dispersed easily in hexane to form desired MnS nanoparticles. FIG. 15 shows the TEM (Transmission Electron Microscope) image of bullet-shaped MnS nanoparticles with average size of 17 nm (thickness)×44 nm (length).

Embodiment 10: Synthesis of Hexagon-Shaped MnS Nanoparticles

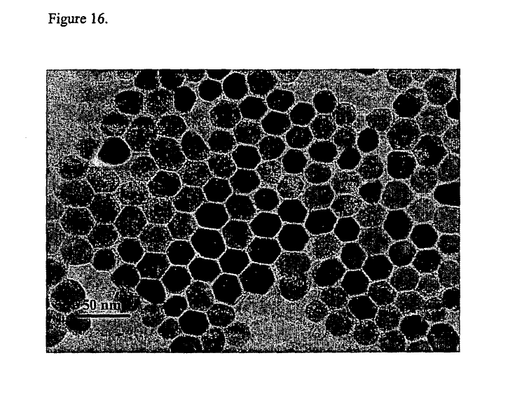

Hexagon-shaped manganese sulfide nanoparticles were synthesized using the same reaction conditions described in Embodiment 8, except that the amount of the MnCl₂ used was increased to 6 mmol and the aging time was increase to 6 hours. An exemplary TEM image of the 9 nm hexagon-shaped manganese sulfide nanoparticles synthesized according to the present invention is as shown in FIG. 16.

Embodiment 11: Synthesis of Mn²⁺ Doped Zinc Sulfide Nanoparticles

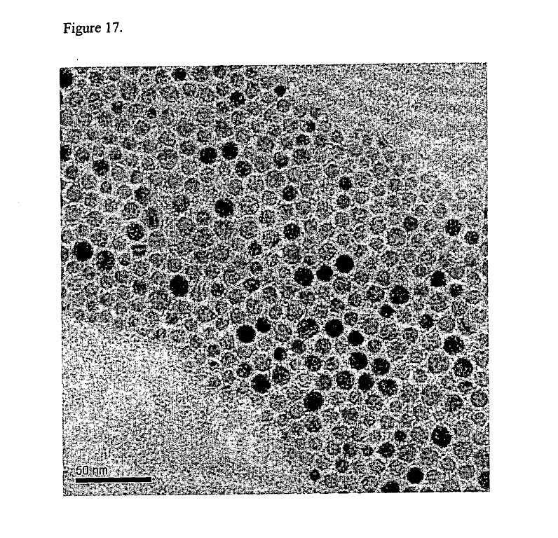

Zinc-manganese-oleylamine solution was prepared by heating 10 ml of oleylamine containing 2 mmol of ZnCl₂ and 0.1 mmol of MnCl₂ at 170° C. for 1 hour. 6 mmol of sulfur dissolved in 5 ml oleylamine was injected to zinc-manganese-oleylamine solution at room temperature. This mixture was heated to 240° C. and aged for 2 hour at the same temperature. The resulting solution was cooled to room temperature, and ethanol was added to yield a white precipitate, which was then separated by centrifuging. The resulting supernatant was discarded. After repeating this washing process at least three times, remaining ethanol was removed by vacuum drying. The resulting product was re-dispersed easily in hexane to form desired Mn-doped zinc sulfide nanoparticles. The TEM image of the resulting product, Mn²⁺ doped zinc sulfide nanoparticles, synthesized by the methods presented here according to the present invention is shown in FIG. 17.

### INDUSTRIAL APPLICABILITY

The uniform and highly crystalline nanoparticles of metal sulfide, and multi-metallic sulfide synthesized according to the present invention display very unique and good and consistent electrical, magnetic as well as optical properties. Particularly, their optical property due to excellent uniformity in size of the nanoparticles is attractive for using such nanoparticles as display devices. Also, it is possible to apply to industrial production because of using environmentally friendly and low-cost precursor. The nanoparticles of multi-metallic sulfides are also readily synthesized according to the present invention and the nanoparticles of multi-metallic sulfides can be applied to phosphors for flat-panel display and biological labeling.

1. A method for synthesizing nanoparticles of metal sulfides and multi-metallic sulfides, comprising the steps of;
forming metal-surfactant complexes by reacting metal precursors and surfactants in a solvent,
synthesizing nanoparticles of metal sulfides and multi-metallic sulfides by reacting said metal-surfactant complexes and sulfur reagent at high temperature, and
completing formation of said synthesized nanoparticles of metal sulfides and multi-metallic sulfides by separating and retrieving said nanoparticles of metal sulfides by adding a poor solvent followed by centrifuging.

2. The method of claim 1, wherein said metal precursors include the following metal salts composed of metal cations including typically cadmium[Cd], zinc[Zn], mercury[Hg], lead[Pb], manganese[Mn], iron[Fe], cobalt[Co], nickel[Ni], molybdenum[Mo], vanadiumm, niobium[Nb], aluminum[Al], titanium[Ti], copper[Cu], gallium[Ga], germanium[Ge], indium[In], tin[Sn], antimony[Sb], tantalum[Ta], tungsten[W], and anions including typically chloride[Cl], bromide[Br], nitrate[NO₃⁻], sulfate[SO₄²⁻], acetate[CH₃COO], acetylacetonate[CH₃COCH═C(O⁻)CH₃], fluoride[F⁻], phosphate [PO₄³⁻], oxalate[COO], perchlorate[ClO₄] and alkoxides[RO⁻] are used as metal precursors. Furthermore, mixtures of any combinations of two or more metal salts listed above are also used as catalyst precursors. Typical precursors are metal chlorides including typically lead chloride [PbCl₂], zinc chloride [ZnCl₂], cadmium chloride [CdCl₂], manganese chloride [MnCl₂], silver chloride [AgCl], copper chloride [CUCl₂], and metal acetates including typically lead acetate [Pb(OAc)₂], zinc acetate [Zn(OAc)₂], cadmium acetate [Cd(OAc)₂], manganese actate [Mn(OAc)₂], and metal nitrates including typically lead nitrate [Pb(NO₃)₂], zinc nitrate [Zn(NO₃)₂]₁, cadmium nitrate [Cd(NO₃)₂], manganese nitrate [Mn(NO₃)₂], silver nitrate [AgNO₃], copper nitrate [Cu(NO₃)₂], and metal sulfates including typically lead sulfate [PbSO₄], zinc sulfate [ZnSO₄], cadmium sulfate [CdSO₄], manganese sulfate [MnSO₄], silver sulfate [Ag₂SO₄], and copper sulfate [CuSO₄].

3. The methods of claim 1, wherein the elemental sulfur is used as sulfur source and sulfiding reagent.

4. The methods of claim 1, wherein said surfactants for stabilizing the nanoparticles are cationic surfactants including typically alkyltrimethylammonium halides such as cetyltrimethylammonium bromide, neutral surfactants including typically oleic acid, trioctylphosphine oxide(TOPO), triphenylphosphine(TPP), and trioctylphosphine(TOP), alkyl amines, RNH₂, where R is alkyl groups with 3-18 carbons, such as oleylamine, octylamine, and hexadecylamine, and trialkylamine and alkyl thiols, and anionic surfactants including typically sodium alkyl sulfates and sodium alkyl phosphates. Mixtures of two or more surfactants are also used.

5. The methods of claim 1, wherein said solvents include typically ethers such as octyl ether, butyl ether, hexyl ether and decyl ether, and heterocyclic compounds such as pyridine and tetrahydrofurane(THF), and aromatic compounds such as toluene, xylene, mesitylene, benzene, and dimethyl sulfoxide(DMSO), and dimethylformamide(DMF), and alcohols such as octyl alcohol, and decanol, and hydrocarbons such as heptane, octane, decane, dodecane, tetradecane, hexadecane as well as water.

6. The method of claim 1, wherein said metal sulfide nanoparticles are precipitated from said dispersed solution by adding a poor solvent followed by centrifugation process to obtain said metal nanoparticles in a powder form, herein poor solvent includes polar solvent, such as ethanol, acetone and methanol.

7. The method of claim 1, wherein the molar ratio of said metal precursor to said surfactant ranging from 1:0.1 to 1:100 is maintained.

8. The method of claim 1, wherein the molar ratio of said metal precursor to said sulfur ranging from 1:0.1 to 1:100 is maintained.

9. The method of claim 1, wherein the reaction temperature for the preparation of said metal-surfactant complexes ranges from 20° C. to 400° C.

10. The method of claim 1, wherein the heating rate for reaching the temperature of preparing metal-surfactant complex is in the range from 0.2° C./min. to 20° C./min.

11. The method of claim 1, wherein the reaction temperature for the reaction of said metal-surfactant complexes and sulfur is in the range from 20° C. to 400° C.

12. The method of claim 1, wherein the heating rate for reaching the reaction temperature for the reaction of said metal-surfactant complexes and sulfur is in the range from 0.2° C./min. to 20° C./min.
